(19) United States
(12) Patent Application Publication
(10) Pub. No.: US 2014/0229239 A1
(43) Pub. Date: Aug. 14, 2014

(54) FACE RETIREMENT TOOL

(71) Applicant: BANK OF AMERICA CORPORATION, Charlotte, NC (US)

(72) Inventors: Anthony Matthew Hitchman, Brooklyn, NY (US); James I. Brown, Dover, MA (US)

(73) Assignee: Bank of America Corporation, Charlotte, NC (US)

(21) Appl. No.: 13/767,660

(22) Filed: Feb. 14, 2013

(51) Int. Cl. G06T 11/60

(52) U.S. Cl. CPC G06T 11/60
USPC 705/7.35; 345/619

(57) ABSTRACT

Embodiments of the invention provide for systems, computer program products, and methods for a face retirement tool that allows a user to help plan for retirement. The face retirement tool receives an image by capturing an image of the user. In some embodiments the person takes an image of the user's face using an interface in the face retirement tool. The face retirement tool ages the image of the user's face into one or more separate images illustrating the user's face at different ages at points of time in the future. The face retirement tool further provides retirement tools to the user through an interface, in order to assist the user in planning for retirement. The retirement tools may be accessed through links in the face retirement tool or the retirement tools may be included as part of the face retirement tool.

### BACKGROUND

Saving money is helpful for planning for retirement. The more tools a person has, and/or the better the tools are, the person's ability to plan for retirement is improved.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for a face retirement tool that allows a user (e.g., current customer, prospective customer, etc.) to help plan for retirement. The face retirement tool receives an image by capturing an image of the user. In some embodiments the person takes an image of the user's face using an interface in the face retirement tool accessed through the use of the user's computer system. The face retirement tool ages the image of the user's face into one or more separate images illustrating the user's face at different ages at points of time in the future. The face retirement tool displays the one or more aged images to the user through an interface. The face retirement tool further provides retirement tools to the user through an interface, in order to assist the user in planning for retirement. The retirement tools may be accessed through links in the face retirement tool or the retirement tools may be included as part of the face retirement tool.

Embodiments of the invention comprise systems, computer program products, and methods that receive a face image of a user; create an aged face image from the face image of the user, wherein the aged face image illustrates a representation of an age of the user at a future point in time; display the aged face image to the user in an interface; and display retirement tools to the user.

In another embodiment, the invention creates the aged face image from the face image of the user comprises creating two or more aged face images from the face image of the user.

In further accord with an embodiment, the invention receives a selection from the user to view one of the two or more aged face images.

In yet another embodiment, the invention receives user information about the user, wherein the user information comprises at least a user age and a user gender.

In still another embodiment, the invention captures the face image of the user.

In another embodiment, the invention provides information regarding an estimated cost of a product at the future point in time associated with the aged faced image.

In further according with an embodiment, the invention receives a selection from the user to edit the aged face image.

In yet another embodiment, the invention receives a selection from the user to share the aged face image through social media.

In still another embodiment, the invention receives a selection from the user to access the retirement tools.

In another embodiment of the invention the retirement tools comprise a retirement number calculator tool, investment tools, and an open retirement account tool.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a high level process flow illustrating a face retirement process, in accordance with one embodiment of the invention;

FIG. 2 is a block diagram illustrating a face retirement tool system environment, in accordance with an embodiment of the invention;

FIG. 3 is a process flow illustrating a face retirement process, in accordance with one embodiment of the invention;

FIG. 4 is a face retirement tool set-up interface illustrating a representation of the user, in accordance with an embodiment of the invention;

FIG. 5 is a face retirement tool interface illustrating a current representation of the user and retirement tools available to the user, in accordance with an embodiment of the invention;

FIG. 6 is a face retirement tool interface illustrating a representation of the user at a point in time in the future and retirement tools available to the user, in accordance with an embodiment of the invention;

FIG. 7 is a face retirement tool interface illustrating a representation of the user at a point in time in the future and retirement tools available to the user, in accordance with an embodiment of the invention;

FIG. 8 is a face retirement tool interface illustrating a representation of the user at a point in time in the future and retirement tools available to the user; in accordance with an embodiment of the invention;

FIG. 9 is a face retirement tool interface illustrating a representation of the user at a point in time in the future and retirement tools available to the user, in accordance with an embodiment of the invention;

FIG. 10 is a face retirement tool interface illustrating a representation of the user at a point in time in the future and retirement tools available to the user, in accordance with an embodiment of the invention;

FIG. 11 is a face retirement tool interface illustrating a representation of the user at a point in time in the future and retirement tools available to the user, in accordance with an embodiment of the invention;

FIG. 12 is a face retirement tool interface illustrating a representation of the user at a point in time in the future and retirement tools available to the user, in accordance with an embodiment of the invention;

FIG. 13 is a face retirement tool interface illustrating a representation of the user at a point in time in the future and a face-aging control panel, in accordance with an embodiment of the invention;

FIG. 14 is a face retirement tool interface illustrating a representation of the user at a point in time in the future and a retirement number calculator tool available to the user, in accordance with an embodiment of the invention;

FIG. 15 is a face retirement tool interface illustrating a representation of the user at a point in time in the future and investment tools available to the user, in accordance with an embodiment of the invention; and

FIG. 16 is a face retirement tool interface illustrating a representation of the user at a point in time in the future and an open account tool, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

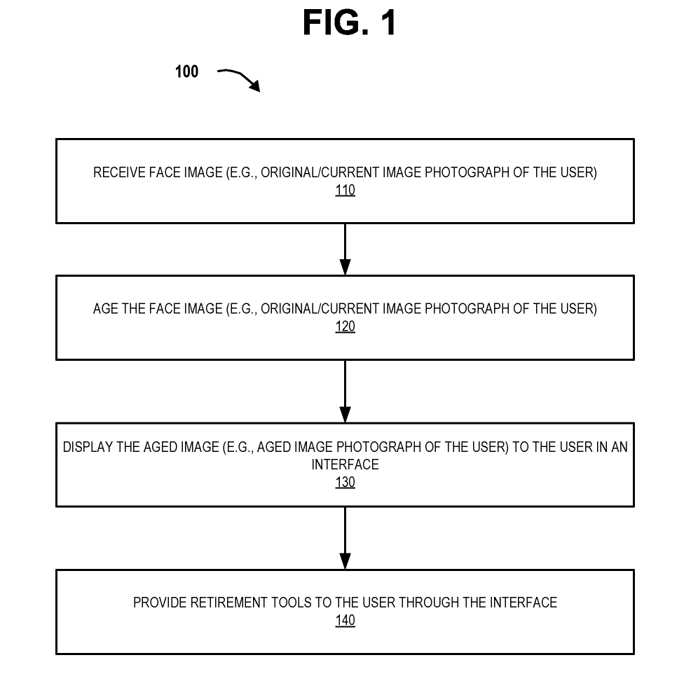

Thus, methods, systems, computer programs, and the like, are herein disclosed that provide for a face retirement tool (e.g., face retirement application 17), that allows a user 4 (e.g., current customer, prospective customer, etc.) to help plan for retirement. FIG. 1 illustrates a high level face retirement process 100, according to one embodiment of the invention. As illustrated by block 110 in FIG. 1, the face retirement tool receives a current representation (e.g., digital image like a digital photograph, etc.) of the user 4. In some embodiments the user 4 takes an image of the user's face using an interface in the face retirement tool. As illustrated by block 120, the face retirement tool ages the current representation of the user's face into one or more aged representations illustrating the user's face at different ages in the future. As illustrated by block 130, the face retirement tool displays the one or more aged representations to the user 4 through an interface. The face retirement tool, along with the one or more aged representations, also provides retirement tools to the user 4 through the interface, as illustrated by block 140 of FIG. 1.

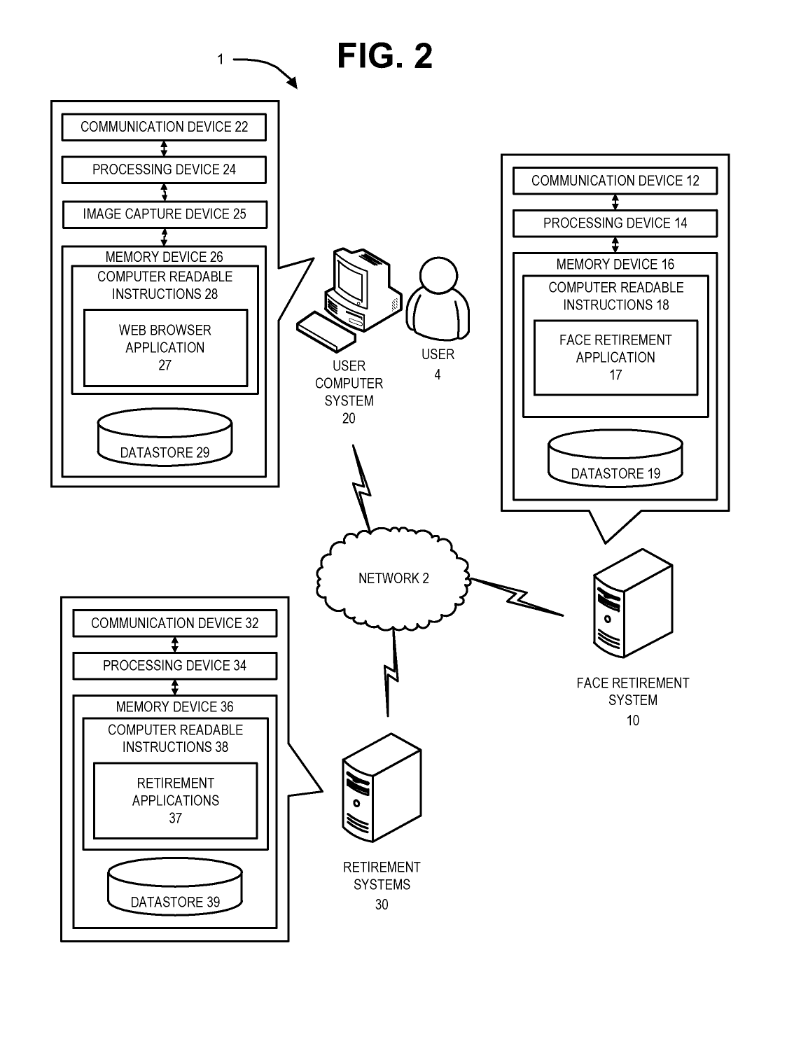

FIG. 2 illustrates a face retirement system environment 1, in accordance with an embodiment of the present invention. As illustrated in FIG. 2, one or more user computer systems 20 are operatively coupled, via a network 2, to a face retirement system 10, and one or more retirement systems 30. In this way one or more users 4 may utilize the user computer systems 20 to connect to the face retirement system 10 in order to access a face retirement application 17 for utilizing the face retirement tool, as well as to connect to the retirement systems 30 to access retirement applications 37 (e.g., retirement tools) in order to help plan for retirement.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

In some embodiments of the invention the one or more users 4 are current customers or potential customers that are using the face retirement tool to help the plan for retirement.

As illustrated in FIG. 2, a user 4 accesses the face retirement system 10 through a user computer system 20. The user computer system 20 may be a desktop, laptop, tablet, mobile device (e.g., smartphone device), or any other type of computer that generally comprises a communication device 22, a processing device 24, an image capture device 25, and a memory device 26. As used herein, the term “processing device” generally includes circuitry used for implementing the communication and/or logic functions of a particular system. For example, a processing device 24 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 24 may include functionality to operate one or more software programs based on computer-readable instructions 28 thereof, which may be stored in a memory device 26.

The processing device 24 is operatively coupled to the communication device 22, the image capture device 25, and the memory device 26. The processing device 24 uses the communication device 22 to communicate with the network 2 and other devices on the network 2, such as, but not limited to, the face retirement system 10, the retirement systems 30, and/or other systems utilized by a business. As such, the communication device 22 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the user 4.

As illustrated in FIG. 2, the user computer systems 20 may have an image capture device 25, such as a digital camera, web camera, etc. (internal or external), that allows a user to take a self-image, such as a representation of the user's face. As further illustrated in FIG. 2, user computer systems 20 may have computer-readable instructions 28 stored in the memory device 26, which in one embodiment includes the computer-readable instructions 28 of a web browser application 27 that allows the user 4 to access the face retirement application 17, the retirement applications 37, etc. In some embodiments, the memory device 26 includes a datastore 29 for storing data related to the user computer system 20, including but not limited to data created and/or used by the web browser application 27. The web browser application 27 may be used by the user 4 to access the face retirement application 17, to transfer an image of the user's face, and to receive aged face images, future good and service information (hereinafter “product information”), and to access retirement tools through a face retirement interface 500, 600.

As illustrated in FIG. 2, the face retirement system 10 generally comprises a communication device 12, a processing device 14, and a memory device 16. The processing device 14 is operatively coupled to the communication device 12 and the memory device 16. The processing device 14 uses the communication device 12 to communicate with the network 2 and other devices on the network 2, such as, but not limited to, the user computer system 20 and the retirement systems 30. As such, the communication device 12 generally comprises a modem, server, or other device for communicating with other devices on the network 2.

As further illustrated in FIG. 2, the face retirement system 10 comprises computer-readable instructions 18 stored in the memory device 16, which in one embodiment includes the computer-readable instructions 18 of a face retirement application 17 (e.g., face retirement tool). In some embodiments, the memory device 16 includes a datastore 19 for storing data related to the face retirement system 10, including, but not limited to, data created and/or used by the face retirement application 17.

The face retirement application 17 is a tool used to provide the user with visual displays illustrating one or more aged representations of the user 4 at periods of time in the future based on an initial representation of the user 4. The face retirement application 17 also provides future product information, as well as retirement tools that can be used to help the user 4 plan for retirement, as is described in further detail below.

As illustrated in FIG. 2, the retirement systems 30 generally comprises a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the user computer system 20 and the face retirement system 10. As such, the communication device 32 generally comprises a modem, server, or other device for communicating with other devices on the network 2.

As further illustrated in FIG. 2, the retirement systems 30 comprise computer-readable instructions 38 stored in the memory device 36, which in one embodiment includes the computer-readable instructions 38 of retirement tools (e.g., retirement applications 37. In some embodiments, the memory device 36 includes a datastore 39 for storing data related to the retirement systems 30, including but not limited to data created and/or used by the retirement applications 37.

The retirement applications 37 (e.g., retirement tools) are tools used to provide the user 4 with the ability to determine a retirement number (e.g., a savings goal for retirement), to use investment tools (e.g., tools used for creating a plan for reaching the retirement number), and to open retirement accounts (e.g., implementing the retirement plan by updating or opening accounts), as is described in further detail below.

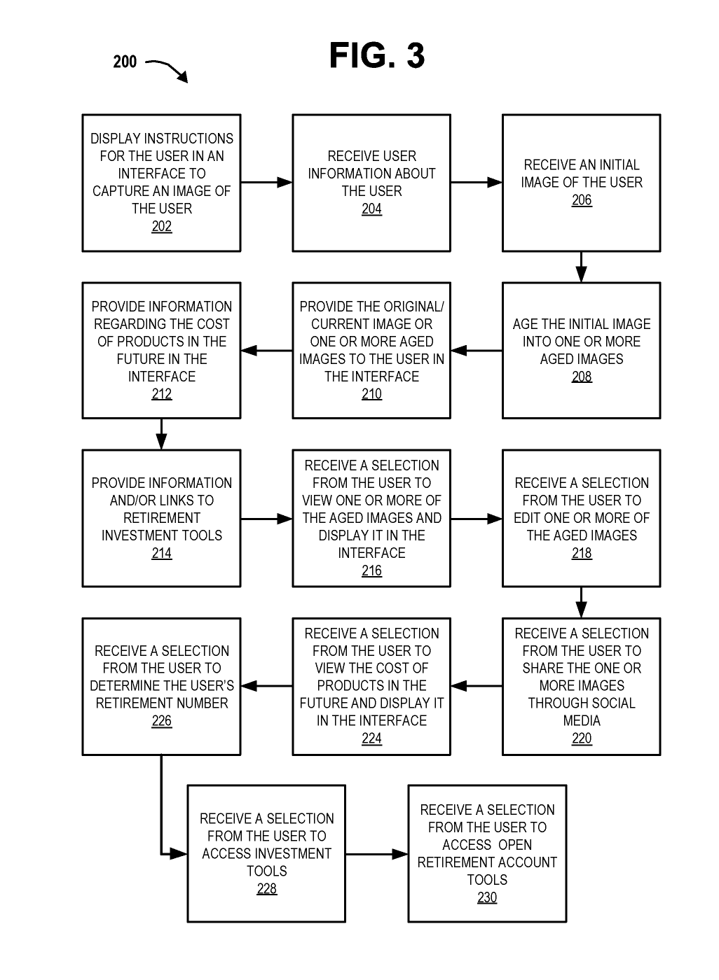

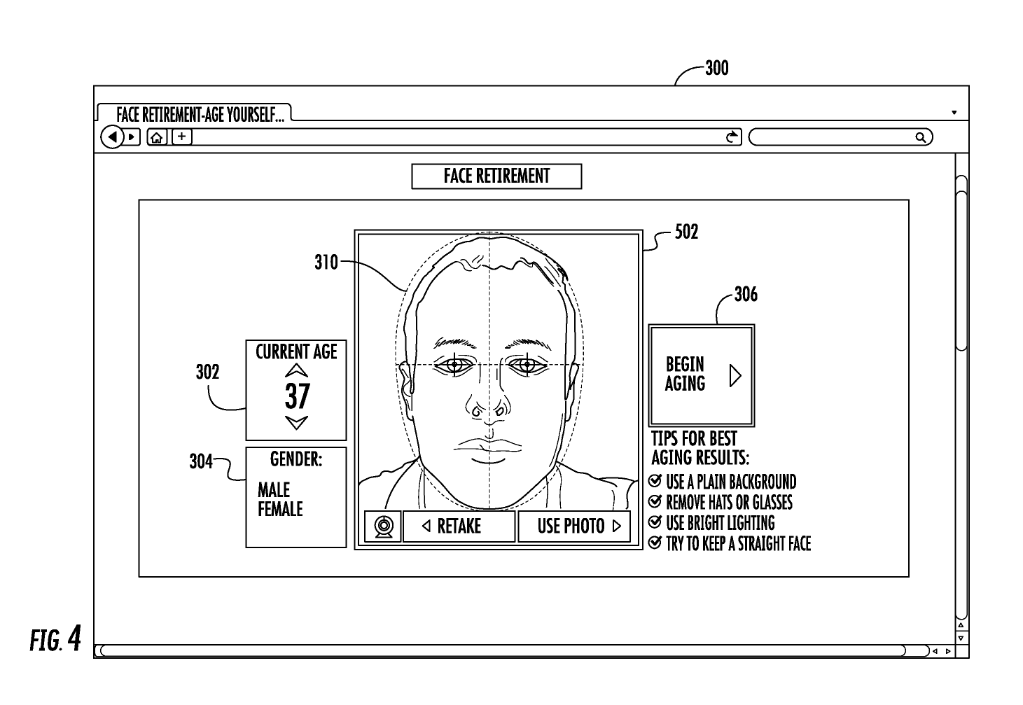

FIG. 3 illustrates the face retirement process 200, in accordance with one embodiment of the invention. As illustrated in block 202 of FIG. 3, the user 4 accesses the face retirement tool, which displays instructions for the user 4 for utilizing the face retirement tool in a face retirement set-up interface 300. As illustrated in FIG. 4, the face retirement set-up interface 300 prompts the user to enter user information. In some embodiments the user information is the user's age 302 and the user's gender 304, which helps to create the aged images of the user's face. In other embodiments of the invention the user information may comprise the user's desired retirement age, how much the user has saved, the user's annual income, the user's retirement savings per month, and the user's investment style (e.g., capturing the user's percentage investment in stocks/equity, fixed income, and cash). As illustrated by block 204 of FIG. 3 the face retirement tool may receive the user information from the user 4.

As illustrated by block 206 of FIG. 3 the face retirement tool receives an initial image 502 (e.g., initial representation) of the user 4. In some embodiments, the user 4 may use the image capture device 25 (e.g., computer camera) in the user computer system 20 in order to capture an original (e.g., current) image of the user 4 to use as the initial image 502. As illustrated in FIG. 4, the user 4 can capture the initial image 502, and either use the initial image 502 or retake the initial image 502 by selecting the appropriate buttons in the face retirement set-up interface 300. If the user 4 is satisfied with the initial image 502 the user 4 may select the “begin aging” button 306 in the face retirement set-up interface 300 to begin aging the initial image 502. In other embodiments of the invention, instead of capturing an original (e.g., current) image, the user may upload a previously captured image to use as the initial image 502.

In some embodiments of the invention, regardless of how the initial image 502 is received, the face retirement tool may analyze that the initial image 502 is actually an image of a human face before proceeding with aging the initial image 502. If the initial image 502 is not identified as a human face (e.g., it is an image of an animal or a full length image of the user) then the face retirement tool may reject the image and provide a warning notice or a notice to retake or resubmit a face image. Furthermore, in some embodiments the face retirement tool may determine if the user's face meets size, shape, angle, tilt, position, etc. requirements in order to determine if the initial image 502 is properly taken for aging. For example, if the user 4 is too far outside of, or inside of, a specified target area 310, if the user's face it turned too much to the right or left, if the user's face is tilted at an angle, etc. the face retirement tool may not be able to properly age the initial image 502. If the initial image 502 is acceptable the face retirement tool (or other software) ages the initial image 502 into one or more aged images 602 (e.g., one or more aged representations), as illustrated by block 208 in FIG. 3.

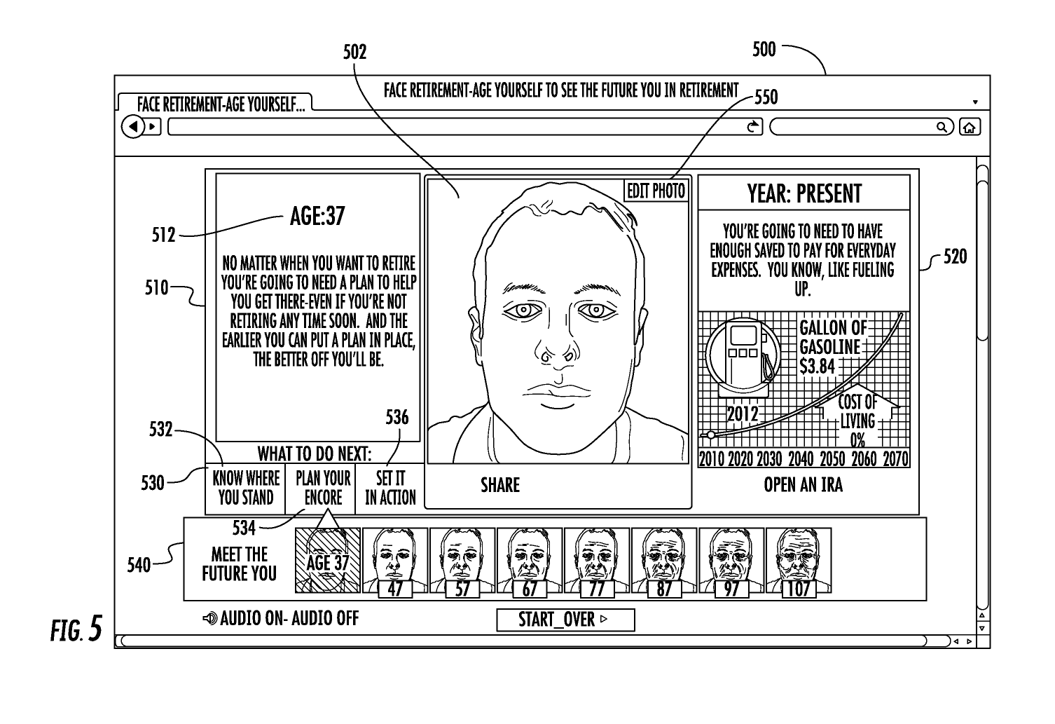

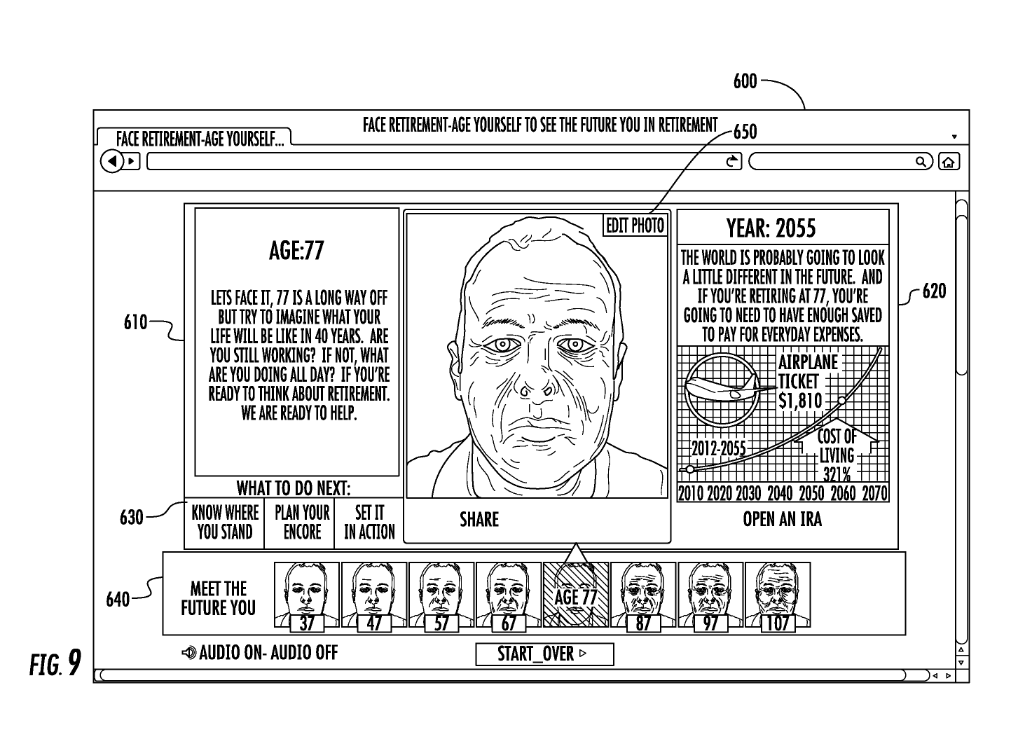

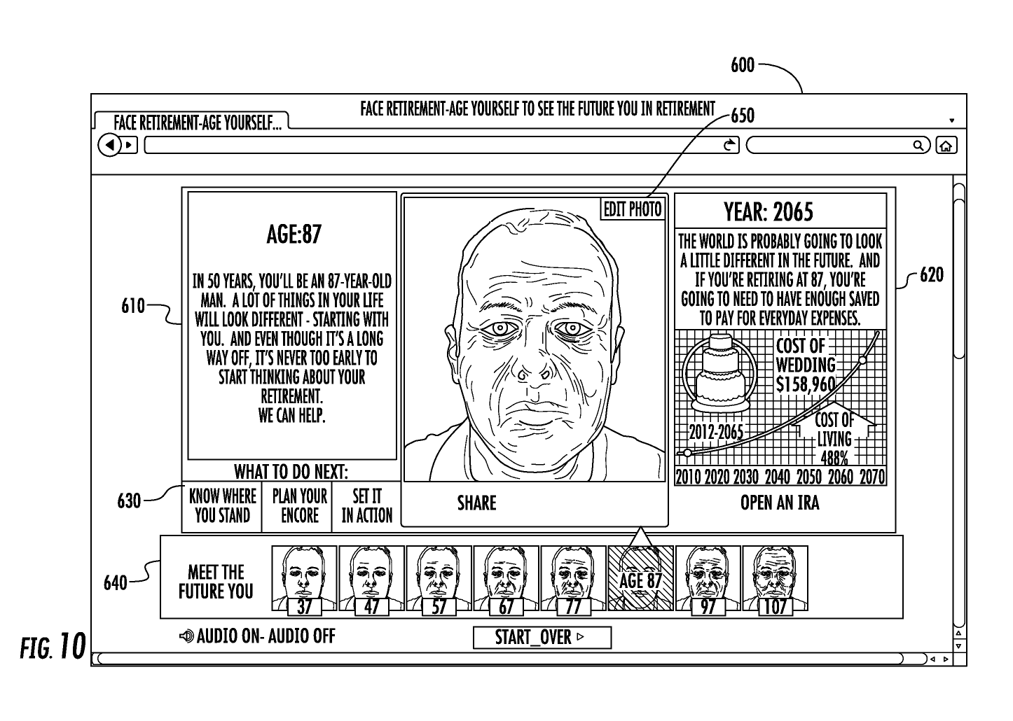

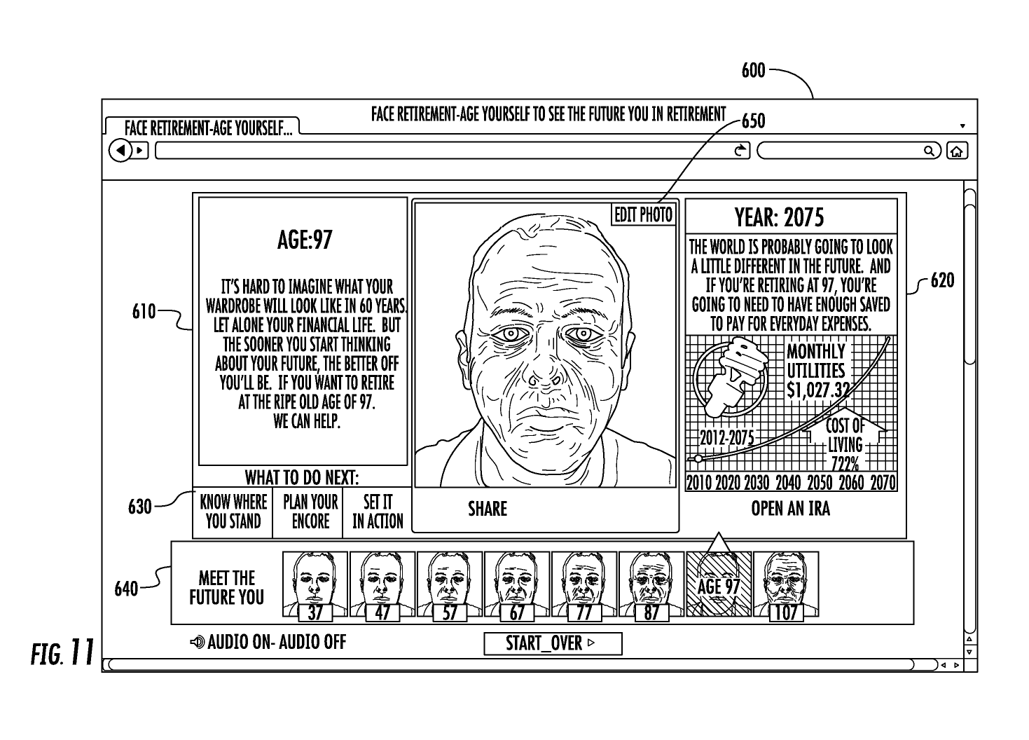

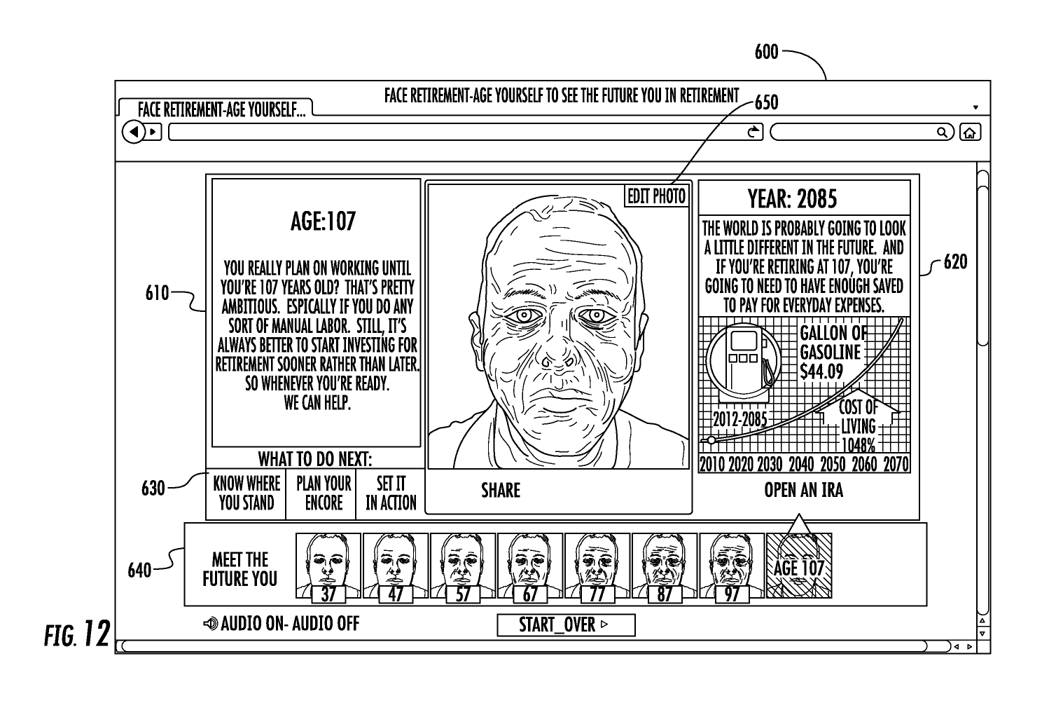

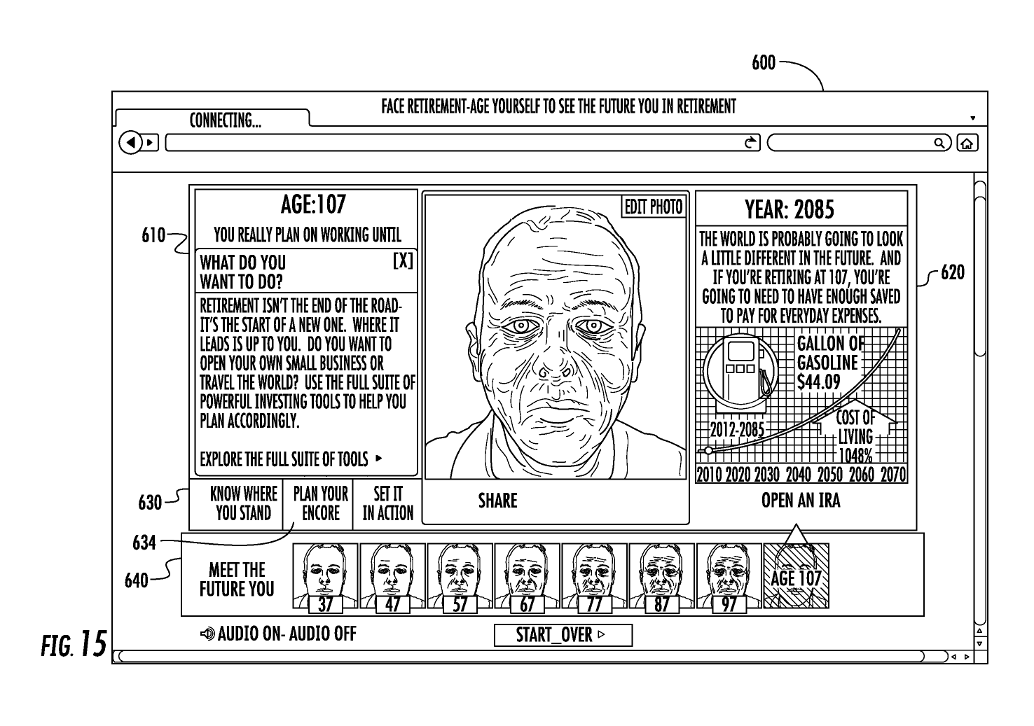

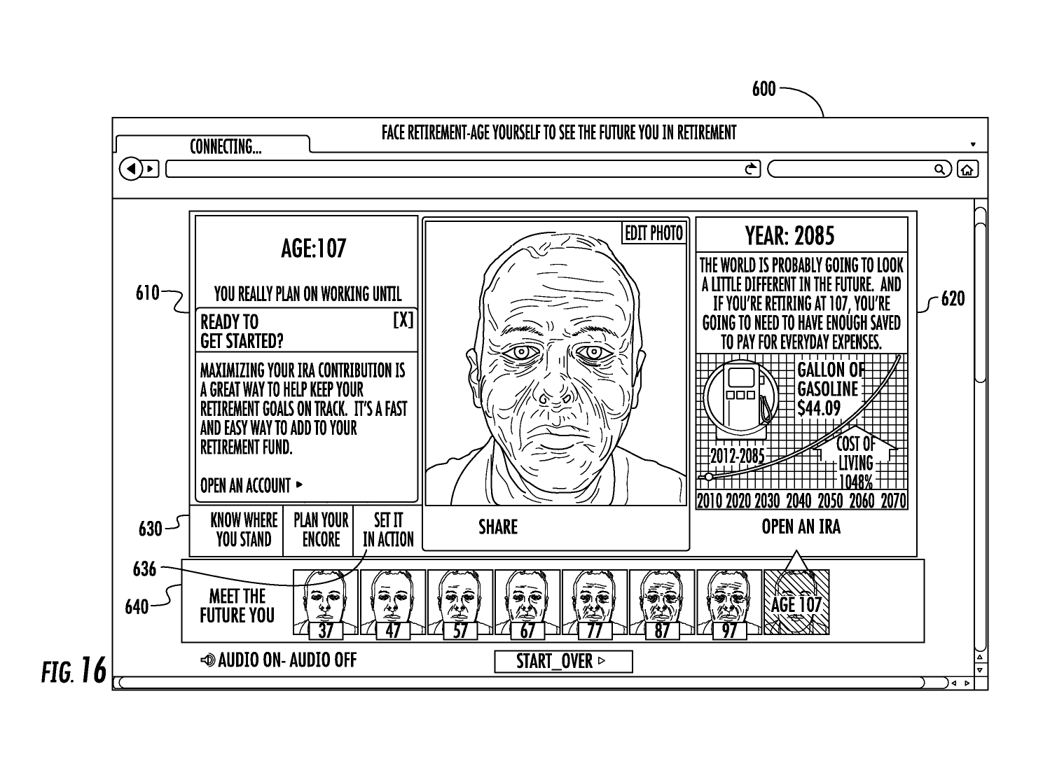

As illustrated by block 210 in FIG. 3, after the face retirement tool creates the one or more aged images 602, the initial image 502, the one or more aged images 602, and the user information may be displayed in an initial interface 500 and one or more aged interfaces 600, as illustrated in FIGS. 5-16. FIG. 5 illustrates the initial interface 500. In some embodiments of the invention, the initial interface 500 illustrates the initial image 502 that user captured using the face retirement tool. The initial interface 500 may also comprise a user information section 510 that may illustrate user information, such as the user's age 512, the user's gender, retirement information, etc.

As illustrated by block 212 in FIG. 3, the face retirement tool may provide product information regarding the cost of products (e.g., goods and services) currently or at future points in time, and display the product information in the initial interface 500 or the aged interfaces 600, along with the initial image 502 or the one or more aged images 602. As illustrated in FIG. 5, the initial interface 500 may have a product information section 520, illustrating the product information, such as the costs of products for the present year. The product information section 520 may provide the user 4 a point of reference indicating the present purchasing power and value of money. In the illustrated embodiment of the invention, the product information section 520 illustrates the average cost of gas for the present year in which the user 4 captures and submits the initial image 502.

Block 214 in FIG. 3 illustrates that the face retirement tool provides information and/or links to retirement tools in a retirement tool section 530. The retirement tools in the retirement tool section 530 are described in further detail later in the application.

As illustrated by block 216 in FIG. 3, the user 4 may view the one or more aged images 602 by making a selection in the aged image section 540 related to one or more of the aged images (e.g., image, text, links, etc.). In some embodiments, as illustrated in FIG. 5, the aged image section 540 comprises thumbnail images, or other like representations, and the user 4 may select one of the one or more thumbnail images to view an aged image 602 representing the user 4 at a point in time in the future in an aged interface 600.

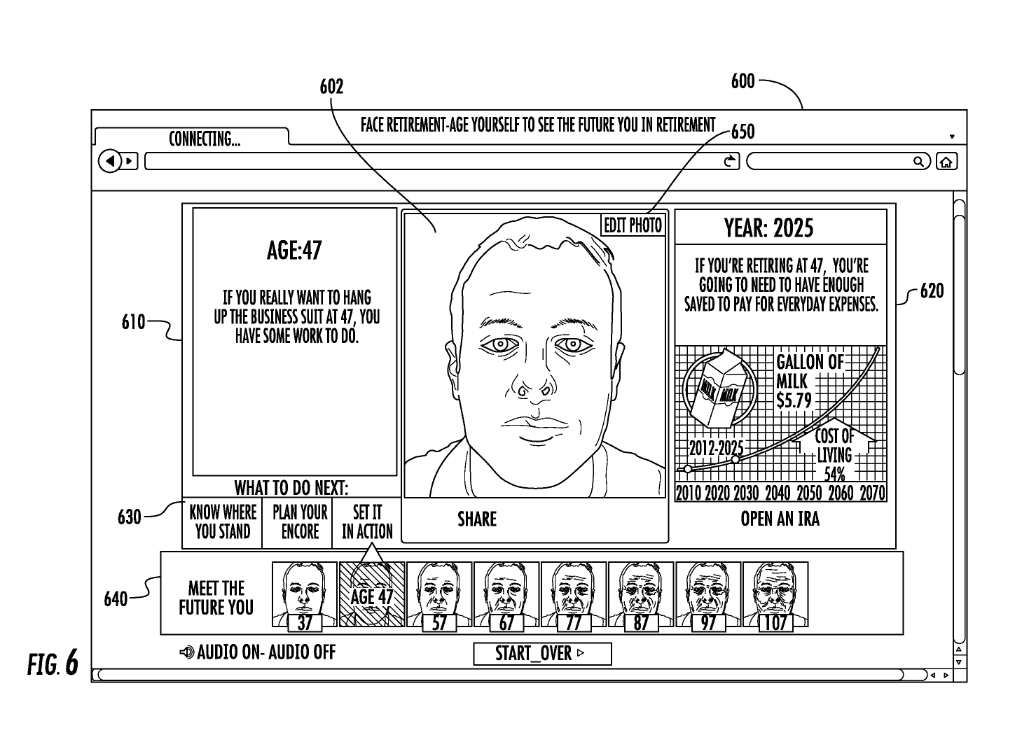

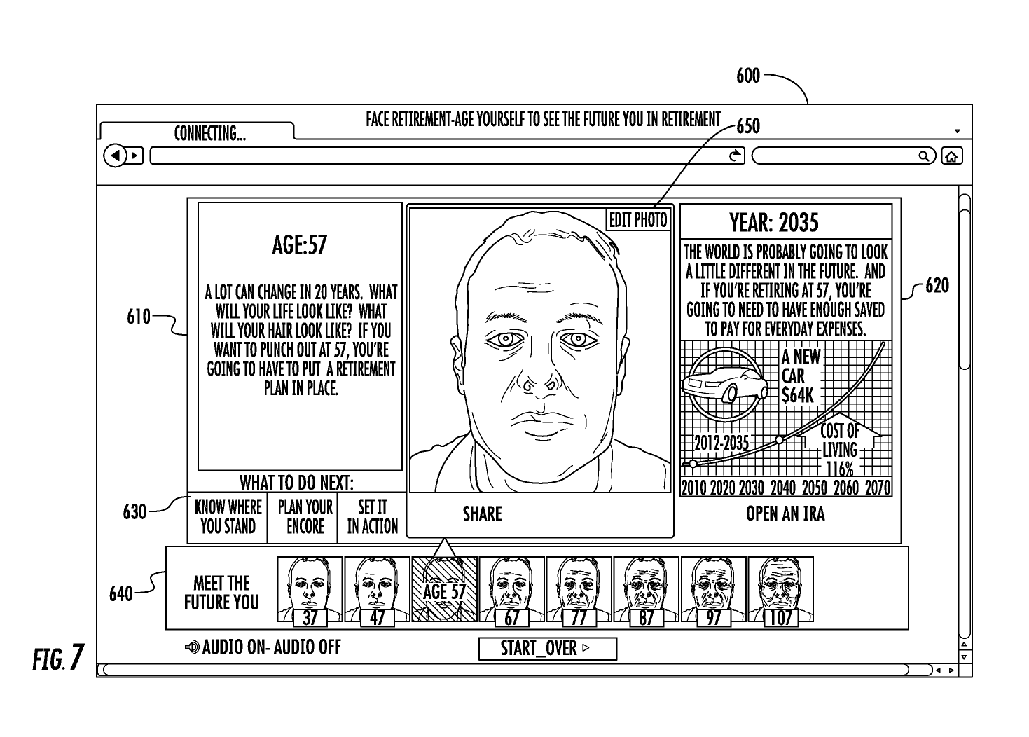

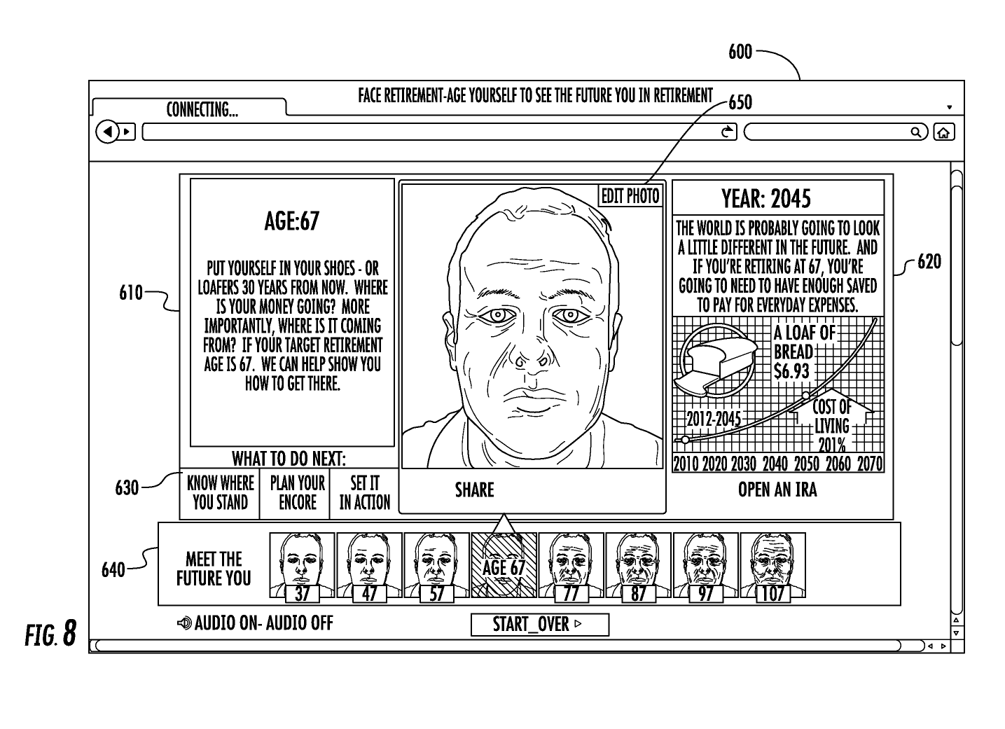

After the selection is made, the face retirement tool receives the user's selection and displays the aged image 602 in an aged interface 600. The various aged interfaces 600, with the one or more aged images 602 are illustrated in FIGS. 6 through 12. For example, FIG. 6 illustrates an aged interface 600 that displays an aged image 602 of the user 4 that is aged ten (10) years into the future from the initial image 502. As illustrated in FIG. 6, the aged interface 600 has the same sections as the initial interface 500 illustrated in FIG. 5, such as the user information section 610, the product information section 620, the retirement tool section 630, and the aged image section 640. The aged image interfaces 600 in FIGS. 7 through 12 are similar to the aged image interface 600 illustrated in FIG. 6 expect for the differences illustrated in the aged image 602 and the content of the user information section 610, and the product information section 620. The user information (e.g., age) in the user information section 610 may change based on the selected aged image 602 that the user is viewing in the aged interface 600. For example, the aged image 602 and user age in FIG. 6 is ten (10) years older than the initial image 502 in the initial interface 500. FIG. 7 illustrates the user 4 as ten (10) years older than the aged image 602 in FIG. 6. FIG. 8 illustrates the user 4 as ten (10) years older than the aged image 602 in FIG. 7, etc. The product information section 630 may also change based on the point in time in the future that the user 4 is viewing in the aged interface 600.

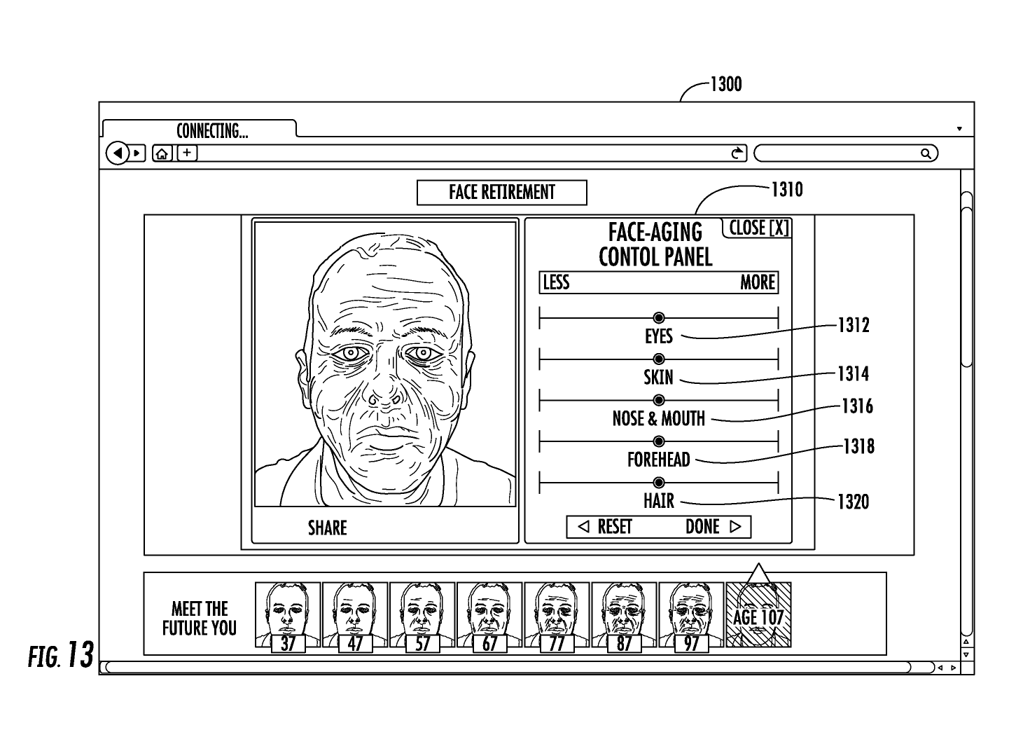

As illustrated by block 218 of FIG. 3, the user 4 may also make a selection to edit the initial image 502, or the one or more aged images 602, by selecting the edit photo button 550, 650. After receiving the indication to edit the image, the system displays the edit image interface 1300. The edit image interface 1300 has an edit image section 1310 that allows the user to edit the initial image 502 or the aged image 602 by adjusting the aging properties of specific features in the image, such as but not limited to the eyes 1312, the skin 1314, the nose and mouth 1316, the forehead 1318, and the hair 1320. In other embodiments of the invention other features, such as but not limited to the ears, chin, neck, cheeks, hair line, etc. may also be adjusted to adjust or change the displayed image of the initial image 502 or aged image 602. As illustrated in FIG. 13, the features in the images may be altered by aging the features less or more than are they are displayed initially by the face retirement tool.

As illustrated in block 220 of FIG. 3, the user may also share the initial image 502 or the one or more aged images 602 through social media accounts. As illustrated in FIGS. 5 through 16, the user 4 may select the share button 560, 660, 1360, in order to share the image through the user's social media account. The user 4 may be required to sign into the user's social media accounts before the initial image 502 or the one or more aged images 602 may be shared through social media. In other embodiments of the invention, along with sharing the images over social media, a link to the face retirement tool may also be associated with the image through social media.

As illustrated by block 224, in some embodiments of the invention, the face retirement tool may allow the user 4 to select different types of products in the aged product information section 620 to identity estimates of the costs of various types of products at different points of time in the future. In other embodiments of the invention, specific products identified by the face retirement tool, which cannot be changed by the user 4, are displayed in the product information section 520, 620 illustrating the estimated cost of the product and the estimated increased cost of living for a point in time in the future.

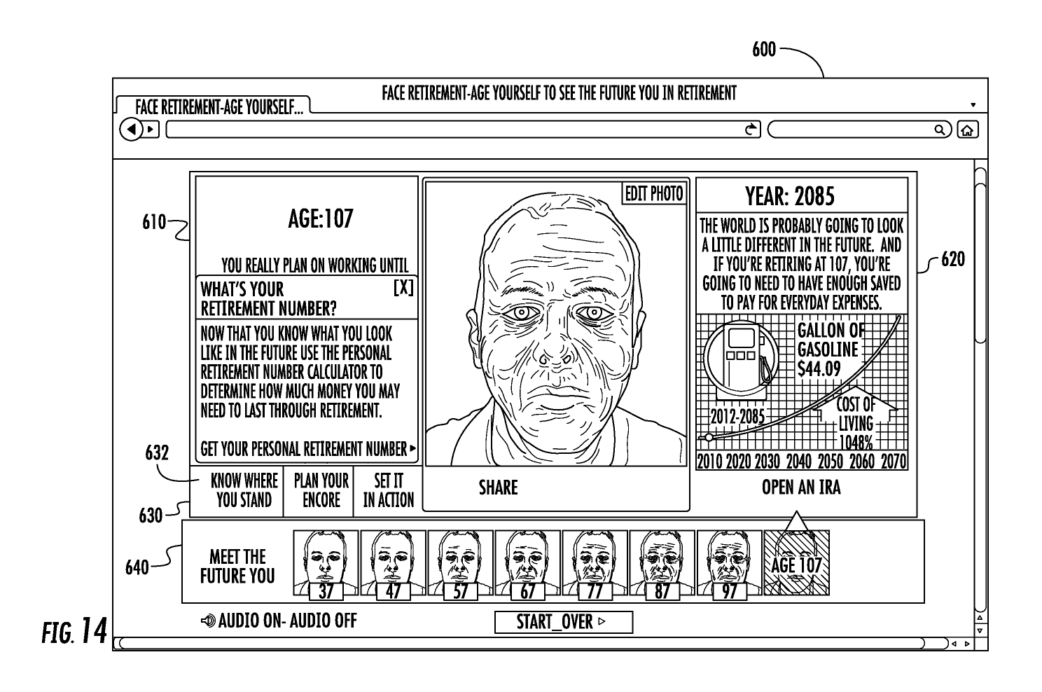

Block 226 in FIG. 3 illustrates that the user 4 may select the retirement tool related to calculating the user's retirement number. As illustrated in FIG. 14 after the user 4 selects the “know where your stand” button 532, 632 the face retirement tool displays a link to a retirement calculator that the user 4 may utilize to estimate how much money the user 4 may need in order to retire. After the selected link is received by the face retirement tool, the face retirement tool presents the user 4 a retirement calculator interface that allows the user 4 to calculate the user's estimated retirement number. In some embodiments of the invention, the retirement calculator interface is displayed directly in the initial interface 500 or in the aged image interface 600. In other embodiments, the retirement calculator interface is displayed to the user in another interface outside of the initial interface 500 and the aged image interface 600. In some embodiments of the invention, the face retirement tool may display the retirement calculator directly to the user 4 after the “know where you stand” button 532, 632 is selected by the user 4. In some embodiments of the invention the user 4 may be required to answer questions regarding the user's age, desired retirement age, how much the user has saved, the user's annual income, the user's retirement savings per month, and the user's investment style (e.g., capturing the user's investment in stocks/equity, fixed income, and cash). In other embodiments at least some of this information may have already been captured by the face retirement tool and stored as user information. Using the retirement calculator allows the user 4 to determine an estimated retirement number that may be used as a goal for retirement planning.

As illustrated by block 228 in FIG. 3, the user may select to access investment tools by selecting the “plan your encore” button 534, 634. After the selection, the face retirement tool displays a link to the investment tools that the user 4 may utilize for retirement planning. After the selected link is received by the face retirement tool, the face retirement tool presents to the user 4 an investment tool interface that allows the user 4 to plan for retirement. In some embodiments of the invention, the investment tool interface is displayed directly in the initial interface 500 or in the aged image interface 600. In other embodiments, the investment tool interface is displayed to the user in another interface outside of the initial interface 500 and the aged image interface 600. In some embodiments of the invention, the face retirement tool may display investment tools directly to the user 4 after the “plan your encore” button 534, 634 is selected by the user 4. The investment tools may include a retirement evaluator tool for assessing if the user 4 is on track to meet the user's retirement goals; an asset allocator tool to determine the user's risk tolerance, and current and target asset allocations; a net worth estimator tool to determine the user's net worth; a college planning tool to save for education; and a performance analysis tool to track the performance of different types of inventions.

As illustrated by block 230 in FIG. 3, the user may request to open retirement accounts by selecting the “set it in action” button 536, 636. After the selection, the face retirement tool displays a link to an open account tool that the user 4 may use to open different types of accounts to save for retirement. After the selected link is received by the face retirement tool, the face retirement tool presents to the user 4 an open retirement account interface that allows the user 4 to open retirement accounts. In some embodiments of the invention, the open retirement account interface is displayed directly in the initial interface 500 or in the aged image interface 600. In other embodiments, the open retirement account interface is displayed to the user in another interface outside of the initial interface 500 and the aged image interface 600. In some embodiments of the invention, the face retirement tool may display the open retirement account interface directly to the user 4 after the “set it in action” button 536, 636 is selected by the user 4. In the open account retirement interface the user 4 may open an IRA account, a trading account, savings account, or other account that may be used for retirement savings.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system comprising:
a memory device having computer readable program code store thereon;
a communication device; and
a processing device operatively coupled to the memory device, and the communication device, wherein the processing device is configured to execute the computer readable program code to:
receive a face image of a user;
create an aged face image from the face image of the user, wherein the aged face image illustrates a representation of an age of the user at a future point in time;
display the aged face image to the user in an interface; and
display retirement tools to the user.

2. The system of claim 1, wherein the processing device configured to execute the computer readable program code to create the aged face image from the face image of the user comprises creating two or more aged face images from the face image of the user.

3. The system of claim 2, wherein the processing device is further configured to execute the computer readable program code to:
receive a selection from the user to view one of the two or more aged face images.

4. The system of claim 1, wherein the processing device is further configured to execute the computer readable program code to:
receive user information about the user, wherein the user information comprises at least a user age and a user gender.

5. The system of claim 1, wherein the processing device is further configured to execute the computer readable program code to:
capture the face image of the user.

6. The system of claim 1, wherein the processing device is further configured to execute the computer readable program code to:
provide information regarding an estimated cost of a product at the future point in time associated with the aged faced image.

7. The system of claim 1, wherein the processing device is further configured to execute the computer readable program code to:
receive a selection from the user to edit the aged face image.

8. The system of claim 1, wherein the processing device is further configured to execute the computer readable program code to:
receive a selection from the user to share the aged face image through social media.

9. The system of claim 1, wherein the processing device is further configured to execute the computer readable program code to:
receive a selection from the user to access the retirement tools.

10. The system of claim 1, wherein the retirement tools comprise a retirement number calculator tool, investment tools, and an open retirement account tool.

11. A computer program product, the computer program product comprising at least one non-transitory computer-readable medium having computer-readable program code portions embodied therein, the computer-readable program code portions comprising:
an executable portion configured to receive a face image of a user;
an executable portion configured to create an aged face image from the face image of the user, wherein the aged face image illustrates a representation of an age of the user at a future point in time;
an executable portion configured to display the aged face image to the user in an interface; and
an executable portion configured to display retirement tools to the user.

12. The computer program product of claim 11, wherein the executable portion configured to create the aged face image from the face image of the user comprises creating two or more aged face images from the face image of the user.

13. The computer program product of claim 12, wherein the computer-readable program code portions further comprise:
an executable portion configured to receive a selection from the user to view one of the two or more aged face images.

14. The computer program product of claim 11, wherein the computer-readable program code portions further comprise:
an executable portion configured to receive user information about the user, wherein the user information comprises at least a user age and a user gender.

15. The computer program product of claim 11, wherein the computer-readable program code portions further comprise:
an executable portion configured to capture the face image of the user.

16. The computer program product of claim 11, wherein the computer-readable program code portions further comprise:
an executable portion configured to provide information regarding an estimated cost of a product at the future point in time associated with the aged faced image.

17. The computer program product of claim 11, wherein the computer-readable program code portions further comprise:
an executable portion configured to receive a selection from the user to edit the aged face image.

18. The computer program product of claim 11, wherein the computer-readable program code portions further comprise:
an executable portion configured to receive a selection from the user to share the aged face image through social media.

19. The computer program product of claim 11, wherein the computer-readable program code portions further comprise:
an executable portion configured to receive a selection from the user to access the retirement tools.

20. The computer program product of claim 11, wherein the retirement tools comprise a retirement number calculator tool, investment tools, and an open retirement account tool.

21. A method comprising:
receiving, by a processing device, a face image of a user;
creating, by the processing device, an aged face image from the face image of the user, wherein the aged face image illustrates a representation of an age of the user at a future point in time;
displaying, by the processing device, the aged face image to the user in an interface; and
displaying, by the processing device, retirement tools to the user.
